(19) United States
(12) Patent Application Publication
(10) Pub. No.: US 2024/0051871 A1
(43) Pub. Date: Feb. 15, 2024

(54) NANO-AMENDED CEMENTITIOUS MATERIALS FOR WASTE STABILIZATION

(71) Applicants: University of South Carolina, Columbia, SC (US); Battelle Savannah River Alliance, LLC, AS\iken, SC (US)

(72) Inventors: Fabio Matta, Columbia, SC (US); Mohammed Baalousha, Columbia, SC (US); Steven M. Serkiz, Aiken, SC (US); Jay Gaillard, Aiken, SC (US); Shohana Iffat, Jersey City, NJ (US)

(73) Assignees: University of South Carolina, Columbia, SC (US); Battelle Savannah River Alliance, LLC, Aiken, SC (US)

(21) Appl. No.: 18/331,395

(22) Filed: Jun. 8, 2023

Related U.S. Application Data
(60) Provisional application No. 63/396,259, filed on Aug. 9, 2022.

(51) Int. Cl. C04B 18/04; C04B 28/04; C04B 28/02; C04B 28/08; C04B 14/02; C04B 20/02; C04B 40/00; G21F 9/16; G21F 9/30; A62D 3/33

(52) U.S. Cl. CPC C04B 18/0472; C04B 28/04; C04B 28/021; C04B 28/08; C04B 14/026; C04B 14/024; C04B 20/023; C04B 40/0046; G21F 9/165; G21F 9/304; A62D 3/33; C04B 2111/00784

(57) ABSTRACT

Described herein are cementitious composite materials incorporating carbon nanostructures (e.g., nanotubes, nanoplatelets, nanoribbons) that are employed as amendments (i.e., admixtures or additives) to cementitious waste forms as a means to enhance radionuclide and hazardous waste (e.g., heavy metals, toxic organics) retention wherein the incorporation of well-dispersed carbon nanostructures yields more effective waste forms through the resulting modification of the cementitious composite nano-, micro-, and meso-structure (e.g., hindering the infiltration of oxygen and the leaching of waste), and the chemical interactions between chemically-affine waste molecules and the amended cementitious composite.

### STATEMENT REGARDING FEDERALLY SPONSORED RESEARCH

This invention was made with government support under DE-SC0012530 awarded by the Department of Energy. The government has certain rights in the invention.

### TECHNICAL FIELD

The subject matter disclosed herein is generally directed to carbon nanostructures (e.g., single- and multiwalled carbon nanotubes, partially-unzipped carbon nanotubes, graphene nanoplatelets, graphene nanoribbons) as amendments (i.e., admixtures or additives) to cementitious materials as a means to enhance waste retention in cementitious stabilized waste forms. Where waste can include radionuclides and hazardous constituents (e.g., heavy metals, toxic organics) in liquid, slurry, or solid forms. Incorporation of well-dispersed carbon nanostructures into cementitious materials can yield stable waste forms that are more resistant to leaching and degradation by reducing the ingress of water and oxygen.

### BACKGROUND

Cement stabilization of liquid, slurry, and solid waste is a customary practice for both industrial and nuclear wastes. A brief description for each sector is described below.

Cement waste forms are typically used to store low-level nuclear waste due to their low cost, strict production regulations, permanence, and low temperature manufacturing levels. One isotope of interest is technetium (Tc); for instance, as of 2009, over 13 million liters of nuclear waste containing Tc as well as toxic heavy metals such as chromium (Cr) were stored at the U.S. Department of Energy Savannah River Site in Aiken, SC. Here, for instance, the ordinary Portland cement (OPC) composite currently used for low-level liquid waste stabilization is called “saltstone” and is made with Type II OPC, fly ash, blast furnace slag, and low-level nuclear waste salt solution. The resulting stabilized solid creates a chemically reducing environment that is designed to reduce anionic forms for the waste to their the less environmentally mobile reduced (oxidized) state (for instance, Tc(IV)).

However, it is difficult to maintain a reducing environment for cementitious waste containing Tc exposed to the environment. When this waste becomes more oxidized, Tc(IV) is rapidly oxidized to the more mobile pertechnetate anion (TcO⁻⁴).

This rapid re-oxidation can occur when Tc is exposed to moderate oxygen levels such as those found in the atmosphere. Accordingly, it is an object of the present disclosure to introduce carbon nanostructures as amendments to cementitious matrix composites to enhance radionuclide retention by limiting the ingress of oxygen into the waste form. The incorporation of well-dispersed carbon nanostructures can yield more environmentally durable waste forms through the resulting modification of the OPC paste nano-, micro-, and meso-structure, thus hindering the infiltration of oxygen.

Various attempts have been made to provide for improved storage structures. For example, Kulagina et al., “Inclusion of liquid radioactive waste into a cement compound with an additive of multilayer carbon nanotubes,” IOP Conference Series: Earth and Environmental Science, 227(5), article 052030, 11 pp. DOI: 10.1088/1755-1315/227/5/052030. Kulagina et al. disclose an admixture of liquid radioactive wastes in inorganic hydraulic binders (a cementation process) with the possibility of applying reinforcing fillers to increase the level of filling of the cement compound. These fillers are multilayered carbon nanotubes (MCNT) and pyrogenic silica (aerosil). However, this work provides: 1) concentrations of carbon nanotubes in the range of 0.5-5% in weight of cement, which is impractical both in terms of cost as well as introduces defects in the composite due to aggregation of nanotubes. Further, pyrogenic silica is employed as an additional additive. Meanwhile, the current disclosure targets concentrations that are between 10 and 5,000 times lower as well as covers other carbon nanoparticle morphologies in addition to MWCNTs.

Tolentino et al., “Study on the pore structure connectivity of graphene-based cement nanocomposite for use radioactive waste repository,” Associação Brasileira De Energia Nuclear (ABEN), 2019 International Nuclear Atlantic Conference (INAC 2019), Santos, SP, Brazil, Oct. 21-25, 2019. This work discloses geometric modeling considering pores with cylindrical shape to evaluate the pore network connectivity. The results showed pore structure connectivity depends on graphene addition percent. However, this work advocates graphene addition of 0% wt. (M1), 0.5% wt. (M2), and 1.0% wt. These levels are impractical because of cost and introduction of defects in the composite due to aggregation of nanotubes. The current disclosure targets concentrations that are between 10 and 1000 times lower for which, in fact, strength also increases. The Tolentino water/cement ratio of the composite is 0.72, which is unrealistically high for practical applications. In fact, it is nearly 50% higher than those provided herein. Nor does Tolentino mention chemical stabilization of radionuclides, which is disclosed in the current disclosure.

U.S. Pat. No. 9,085,487, Large Scale Production of Carbon Nanotubes in Portland Cement, describes a chemical vapor-phase deposition for carbon nanotube synthesis in which cement clinker is used as a ceramic matrix for anchoring transition-metal nanoparticles. Using cement clinker as nanoparticle anchoring base of transition metals allows carbon nanotubes to be generated on cement clinker particles and grains, in this way producing a kind of cement that is nanostructured with carbon nanotubes. By this process, the carbon nanotube synthesis and integration to clinker are carried out in just one continuous and large-scale stage. The process described herein can be applied to conventional cement industry whose production may be rated as tons per day. The present disclosure also proposes—as part of the carbon nanotube synthesis on cement clinker—several enrichment alternatives of cement clinker by using transition metals for producing such nanostructured composite, which may or not be integrated to the conventional cement industry. However, the '487 patent is a CNT synthesis patent with cement clinker as CNT seed. Fundamentally, different than separately combining ordinary Portland cement and CNTs. Further, there is no disclosure of stabilization and/or reduced leaching of radionuclide or metal waste.

CN 103570331A, A radiation-proof composite insulation board doped with carbon nanotubes, University of Jihan, discloses novel wall materials, and relates to a radiation-proof composite insulation board which is produced from raw materials of expanded perlite, water glass, cement, carbon nanotubes and an aluminum alloy grid. The radiation-proof composite insulation board is doped with carbon nanotubes prepared from the following raw materials in parts by weight: 50 parts of expanded perlite, 60-100 parts of water glass, 60-100 parts of cement and 0.1-1.0 part of carbon nanotubes. The radiation-proof composite insulation board doped with the carbon nanotubes has a radiation-proof function on the basis of insulation and fire protection, is suitable for insulation and radiation protection of an external wall of a building, and is a wall insulation material with a wide application prospect. While employing factors of magnitude greater carbon nanotube amounts, this work is also directed to a construction panel with radiation/thermal shielding capabilities, fundamentally different from the current disclosure and the resulting material is a composite of perlite and tetraethyl orthosilicate (TEOS) (water glass), thus a fundamentally different composite than those disclosed herein.

CN 105536702A, Graphene Cement Base Material Capable of Adsorbing Heavy Metal Ions and Preparation Method of Graphene Cement Base Material, University of Dalian Tech., discloses a graphene cement base material capable of adsorbing heavy metal ions and a preparation method for the graphene cement base material, using functionalized graphene, cement, sand, and water. The graphene cement base material has high capability of adsorbing the heavy metal ions in polluted water, can be used in places such as drainage pipelines, channels, artificial river-bed bottoms and sewage settling tanks, can be recycled, and is green and environment-friendly. Unlike the current disclosure, there is no disclosure of enclosing and stabilizing heavy-metal waste and the graphene used is not reported, nor that nano-sized graphene is employed.

CN 111410478A, A Kind of Composite Graphene High-Strength Construction Waste Cement Mortar and Preparation Method, Univ. Anhui Sci. & Technology, discloses a composite graphene high-strength construction waste cement mortar and a preparation method thereof. The performance indexes of the cement mortar obtained by the invention meet the following requirements: the standard compression strength of 28 days is 57.6 MPa, the breaking strength is 9.03 MPa (tested according to GB/T17617-1999 and JGJ/T70-2009); the quality and the strength loss of 150 times of anti-freezing circulation are less than 5% (tested according to GB/T50476-2008); The Cl-content in the product is 0.0067%, and Ira=0.08, Ir=0.15 (according to GB 6566-2010). CN '478 focuses on waste cement in the form of “construction waste mortar” that is sourced from demolished construction. Graphene oxide is added to facilitate hydration (which is questionable as the material, when functionalized, is hydrophilic) and improve strength and other mechanical properties to compensate for the reduced properties of recycled mortar (in fact, in

it is noted that the material “uses GO as reinforcing agent and surfactant, aiming to obtain a high-strength environment-friendly building material”). There is no disclosure of stabilization of radionuclide and metal waste and the current disclosure targets graphitic nanoparticle concentrations that are over 100 times lower than in CN '478.

CN 108069665A A Kind of Graphene Concrete and Its Preparation Process, Weihai Nanhai Carbon Material Tech Research Institute Co Ltd., discloses a graphene concrete and its preparation process. CN '665 provides a graphite alkene concrete, and by weight, raw material is made of following components 150˜220 parts of cement, 150˜220 parts of sea sand, 225˜330 parts of rubble, 5˜18 parts of lignosulfonates, 40˜100 parts of water, 10˜40 parts of silica flour, 15˜45 parts of fly ash, 2˜5 parts of graphene, 3˜6 parts of graphene oxide, 1˜2.5 part of magnesium powder, 2˜12 parts of polypropylene fiber, 5˜˜15 parts of carbon fiber, 0.5˜1 part of ethylene glycol. CN '665 does not disclose cement composites for the stabilization of radionuclide and metal waste. While graphene is considered as amendment, no information is provided regarding the scale of these particles. Further, the concentration of graphene is over 2% by weight of cement. This level is impractical because of cost and introduction of defects in the composite due to graphene aggregation. The current disclosure targets concentrations that are over 10000 times lower.

WO 2013018901, Radiation Absorbent, Univ. Shinshu, discloses a radiation absorbent comprising a carbon nanotube containing encapsulated particles. By encapsulating an element, an inorganic matter or an organic matter having a high radiation absorption capability in the hollow space of the carbon nanotube, a radiation absorbent, which has a capability of highly efficiently absorbing radiation while sustaining the surface properties of the carbon nanotube can be provided. The radiation absorbent sustains the surface properties of the carbon nanotube and, therefore, can be added to or mixed with various materials before using. WO '901 is clearly distinguishable from the current disclosure as it focuses on the treatment of carbon nanotubes to impart radiation absorbing capabilities. This is a completely different material than the cement composites disclosed herein nor can the materials of WO '901 provide the necessary retention characteristics for radionuclide and heavy metal waste.

U.S. Pat. Pub. 2021/0347693, Additives of Graphene Nanomaterials for the Improvement of Cementitious Compositions, Cementitious Composition, a Process for Preparing a Reinforced Concrete, a Reinforced Concrete and Its Use, Graphenano S. L., provides an additive of graphene nanomaterials for the improvement of cementitious compositions, a cementitious composition, a process for preparing a concrete a concrete and use of the concrete. The '693 Pub. provides an additive that includes a mixture of graphene nanofibers, graphene oxide (GO), a dispersing agent (D) and a superplasticizer (SP), comprising at least two graphene nanofibers, selected among graphene nanofibers of high specific surface area (GNF-HS), graphene nanofibers of low specific surface area (GNF-LS) or graphene nanofibers of long length (GNF-LL), wherein the graphene nanofibers have an average diameter comprised between 2 nm and 200 nm, and wherein the addition of graphene nanomaterials with different proportions of at least two graphene nanofibers is fine-tuned for different cementitious compositions of particular properties. The focus in the '693 reference is on graphene nano-amended cement concrete as a construction material that has superior mechanical and durability properties for construction applications. There is no disclosure of stabilization of radionuclide and metal waste, nor any disclosure of the compounds disclosed herein.

U.S. Pat. Pub. 2022/0017418, Cement Reinforced with High Concentrations of Mechanically Dispersed Multiwalled Carbon Nanotubes and Carbon Nanofibers, discloses methods for the dispersion and synthesis of multiwalled carbon nanotube-cement composites with high concentrations of multiwalled carbon nanotubes (MWCNTs) that do not require chemical dispersion aids or dispersion-enhancing chemical surface functionalization are provided. Methods for the dispersion and synthesis of carbon nanofiber-cement composites with high concentrations of carbon nanofibers that do not require chemical dispersion aids or dispersion-enhancing chemical surface functionalization are further provided. While Pub. '418 provides comprehensive experimental and theoretical presentations on salient physical and mechanical properties, there are no test results related to radionuclide or heavy metal waste leaching. Further, there is no disclosure related to prospective use with respect to radionuclide or heavy metal waste forms. Also, the concentration of multiwalled carbon nanotubes is in the range 0.2-0.5% in weight of cement. This level is impractical because of cost and introduction of defects in the composite due to aggregation of nanotubes. The current disclosure targets concentrations that are between 10 and 1000+ times lower.

U.S. Pat. No. 8,871,019, Composition for Construction Materials Manufacturing and the Method of Its Production, King Abdulaziz City Science and Technology, discloses a system or method for efficiently manufacturing construction materials using carbon nanomaterials. The method comprises creating a blend of carbon nanomaterials, wherein the blend of the carbon nanomaterials includes at least one of a carbon nanofiber, a carbon nanotube, a graphite nanoparticle, and an amorphous carbon. The method also includes dispersing the carbon nanomaterials and adding a plasticizer and sand to the dispersed mixture within 3 minutes. The method also includes adding at least one of water and a cement binding agent to the dispersed mixture after the plasticizer and the sand have been added. U.S. '019 provides no data related to radionuclide or heavy metal waste leaching nor any disclosure related to the compounds use as to radionuclide or heavy metal waste forms.

U.S. Pat. No. 9,365,456, Highly-Dispersed Carbon Nanotube-Reinforced Cement-Based Materials, Northwestern University, discloses a composite cement material prepared from cement material and carbon nanotubes, wherein the carbon nanotubes are present from about 0.02 wt % to about 0.10 wt % based on weight of cement material. The process for preparing such cement compositions includes sonicating a mixture of a surfactant, water, and carbon nanotubes; and blending the dispersion and the cement material to form a cementitious paste. The process may also include curing the cementitious paste. The composite cement materials are useful in a variety of cement applications where a reduction in nanoscale flaws and fractures is desired. With respect to the U.S. '456, there are no test results related to radionuclide or heavy metal waste leaching nor disclosure for prospective use as radionuclide or heavy metal waste forms. Further, the concentration of carbon nanotubes is at a minimum 0.02% in weight of cement. The current disclosure provides concentrations that are up to 1000 times lower.

U.S. Pat. Pub. 2008/0134942, Carbon Nanotube-Fiber Reinforced Cement and Concrete, Brenner, Matthew, discloses carbon nanotubes (CNTs) combined with cement, aggregate and plasticizers to form composites with increased strength. CNT reinforced concretes comprising cement, plasticizer, aggregate, and nanotubes, hydrated with water are disclosed. A mixture of CNTs, cement, and plasticizer can be prepared for later admixture with aggregates and water to form composites having improved strength characteristics. A method for increasing the strength of concrete comprising the steps of admixing CNTs and plasticizer with cement, aggregate, and water for hydration is also disclosed. With respect to the current disclosure, there is no disclosure of use related to radionuclide or heavy metal waste leaching nor any disclosure related to prospective use as radionuclide or heavy metal waste forms. Also, the '942 concentration of carbon nanotubes is at a minimum 0.2% by weight of the composite. The current disclosure provides for concentrations that are several orders of magnitude lower.

U.S. Pat. Pub. 2014/0060392, Fiber Reinforced Concrete, Pro Perma Engineered Coatings, LLC, discloses a concrete reinforcing fiber assembly with a plurality of first fibers and at least one co-fiber attached to at least some of the first fibers. The polymeric fibers can additionally comprise carbon nanotubes (“whiskers”) that function by reinforcing the polymeric fiber. The nanotubes are typically admixed with the polymer prior to pulling into a formed fiber. The nanotubes are suitably randomly oriented in the fiber. The nanotubes can be of linear, armchair, zigzag or spiral shape. The nanotubes can have a Young's modulus of from about 0.2 to about 5 TPa, a tensile strength of from about 10 to about 150 GPa and an elongation at break of from about 5 to about 25%. Suitably, reinforced fibers comprise from about 0.1 to about 10%, from about 0.5 to about 5%, from about 0.5 to about 3%, from about 0.5 to about 1%, from about 1 to about 10%, from about 1 to about 5%, from about 1 to about 3%, from about 3 to about 10%, from about 3 to about 5%, or from about 5 to about 10% by weight carbon nanotubes. Vis-à-vis the current disclosure, there are no test results related to radionuclide or heavy metal waste leaching, nor any disclosure related to prospective use as radionuclide or heavy metal waste forms. Additionally, the current disclosure provides for carbon nanotube concentrations that are several orders of magnitude lower.

U.S. Pat. No. 8,426,501, Generation of polymer concretes incorporating carbon nanotubes, STC.UNM, discloses materials and methods for forming CNTs-polymer composites (e.g., CNTs-SBR latex nano-composites and/or CNTs-epoxy nano-composites), CNTs-polymer concrete, and CNTs-polymer modified cementitious composites. In one embodiment, a plurality of CNTs and a surfactant-containing polymer, including a surfactant attached to a polymer chain, can be dispersed within a cementitious matrix to form a CNTs-polymer modified cementitious composite with the surfactant non-covalently bonded to one or more CNTs. 1) The U.S. '501 provides a polymer-modified concrete incorporating carbon nanotubes. The current disclosure does not include polymer modification. Additionally, there is no disclosure related to radionuclide or heavy metal waste leaching nor prospective use as radionuclide or heavy metal waste forms.

JP 2013086275A, Method of manufacturing hardened cement, and hardened cement, Shimizu Construction Co. Ltd., provides a method of manufacturing hardened cement by mixing at least cement, carbon nanotubes, and water together, wherein the cement and carbon nanotubes are mixed under dry conditions to form a mixture in which the carbon nanotubes are cracked to cling to the surfaces of cement particles, and at least water is mixed with the mixture to manufacture the hardened cement. Thus, JP '275 is directed to mechanical reinforcement and provides no disclosures related to radionuclide or heavy metal waste leaching nor prospective use as radionuclide or heavy metal waste forms.

CN 104058676A, High-Toughness Concrete and Preparation Method Thereof, Hongfeng Group Fujian Co. Ltd., provides high-toughness concrete comprising 0.2-0.5 kg/m³ of modified graphene, 150-175 kg/m³ of water, 395-415 kg/m³ of cement, 45-60 kg/m³ of coal ash, 20-35 kg/m³ of slag powder, 1000-1100 kg/m³ of broken stone, 600-700 kg/m³ of fine aggregate and 4.5-7 kg/m³ of a water reducing agent, wherein the modified graphene is water-soluble grapheme of which the surface has hydroxide radicals; the content of the hydroxide radicals is 0.005-0.012 percent. CN '676 is directed to the use of modified graphene to prepare high-toughness concrete, which can effectively improve flexural strength, tensile strength, and deformation capacity of concrete. However, CN '676 provides no disclosures related to radionuclide or heavy metal waste leaching nor prospective use as radionuclide or heavy metal waste forms. Further, CN '676 uses 200-mesh (63 to 74 microns) natural flake graphite as its carbon source. This is not a nanoscale amendment and is fundamentally different from the current disclosure employing nano-scaled carbon nanotubes.

CN 103130466A, Graphene/Cement Matrix Composite Material and Preparation Method Thereof, Shanghai Inst. Ceramics, discloses a graphene/cement matrix composite material and a preparation method thereof. The composite material comprises a cement matrix and graphene which is evenly in-situ dispersed in the cement matrix, wherein the mass ratio of the graphene to the cement matrix is (0.0001-0.5):1; and the graphene is obtained by thinning graphite through high-speed mechanical shearing. In the composite material, the graphene is evenly in-situ dispersed in the cement matrix; and compared with the traditional material prepared through direct mixing, the composite material provided by the invention has more excellent mechanical property and electric property and is applicable to the field of multifunctional construction materials. CN '466 uses mechanical shear force by high-speed shearing (ball milling) to thin graphite into graphene to produce a uniformly dispersed graphene/cement matrix composite. This is fundamentally different to the present disclosure wherein carbon nano-amendment is added in the solution phase and solution dispersion is achieved by chemical functionalization of the amendment and keeping the pH of solution alkaline. The carbon source is not nano-scaled as “graphite can be one or a combination of flake graphite, graphite powder, expandable graphite, and expanded graphite, and its particle size ranges from 50 nm to 10 mm.” Further, the graphene loading mass ratio to the cement matrix is (0.0001-0.5):1, that is, 0.01-50% in mass of cement. This level is impractical because of cost and introduction of defects in the composite due to aggregation of carbon nanostructures. The current disclosure discloses concentrations that are at least 100 (and up to 500,000) times lower. CN '466 does not provide results related to radionuclide or heavy metal waste leaching nor disclose prospective use as radionuclide or heavy metal waste forms.

CN 104387005A, Carbon Nanotube/Cement Composite Material and Preparation Method Thereof, Suzhou Netshape Composite Materials Co Ltd, discloses a carbon nanotube/cement composite material. The composite material comprises the following components in parts by mass: 55-80 parts of Portland cement clinker, 3-6 parts of gypsum, 6-15 parts of carbon nanotubes, 5-10 parts of nano-alumina, 4-9 parts of aluminum silicate fibers, 10-20 parts of liquid epoxy resin, 4.5-8.5 parts of functional additives and 35-55 parts of water. The carbon nanotube/cement composite material has high hardness, high strength, and high toughness, as well as a certain high-temperature resistance, oxidation resistance, corrosion resistance and good electrical conductivity. CN '005 focuses on a carbon nanotube cement composite material, which is a complex composite—epoxy, Portland cement clinkers, surfactant, defoamer, aluminum silicate, and nano-aluminum. The carbon source is only described as carbon nanotubes in roughly 4-10% as “parts”; no clear information is provided on the key aspect of concentration. Carbon nanotubes are dispersed in epoxy resin and then introduced to the inorganic solids and water with an ultrasonic mixer and a vacuum pulled on the composite. This is a fundamentally different procedure compared to the cement composites in the current disclosure. Further, there are no disclosures related to radionuclide or heavy metal waste leaching nor prospective use as radionuclide or heavy metal waste forms.

CN 106946533A, A Kind of Graphene/Cement Mortar Composite and Preparation Method Thereof, Shandong Obo New Mat. Co. Ltd., discloses a graphene/cement mortar composite, including, composite, cement, water, graphite alkenes, and sandstone. CN '533 focuses on preparation of a graphene/cement mortar composite with uniformly dispersed graphene. This process is fundamentally different from the current disclosure where no evaporation is sought after adding the graphitic nanoparticles dispersed in aqueous solution to the dry ingredients. Conversely, the current disclosure employs graphitic nanoparticle morphologies. Further, the carbon source is 0.01-1% by weight of sand, with sand being approximately 50% by weight of the composite. The resulting carbon concentration is at least one order of magnitude higher than those covered in the current disclosure. There are no disclosures related to radionuclide or heavy metal waste leaching nor prospective use as radionuclide or heavy metal waste forms.

The current disclosure addresses the need for retention capabilities of radionuclide and heavy metal waste, such as mercury, lead, and cadmium, and toxic organics, e.g., chlorinated hydrocarbons such as chloroform and carbon tetrachloride. The current disclosure provides that incorporation of well-dispersed carbon nanostructures can yield more environmentally durable waste forms resulting in reduced ingress of water into the waste and, thereby, lower leaching of hazardous constituents.

Citation or identification of any document in this application is not an admission that such a document is available as prior art to the present disclosure.

### SUMMARY

The above objectives are accomplished according to the present disclosure by providing in one embodiment a cement waste form for radionuclide and hazardous-constituent retention. The waste form may include at least one carbon nanostructure added to at least one cementitious composite to modify a structure of the cementitious composite to form at least one nano-amended cementitious composite, at least one waste source incorporated into the nano-amended cementitious composite to form the cement waste form, the at least one carbon nanostructure is present from 0.001% to 0.005% by weight of the at least one cementitious composite, and the cement waste form may be configured to enhance radionuclide and

hazardous-constituent retention by limiting oxygen and water ingress and imparting environmental durability into the cement waste form. Further, the at least one carbon nanostructure may be selected from at least one single-walled nanotube, at least one multiwalled nanotube, at least one partially-unzipped nanotube, at least one graphene nanoplatelet, at least one graphene nanoribbon, and/or combinations of the above. Again, the at least one cementitious composite may be selected from cementitious paste, cementitious mortar, cementitious grout and/or combinations of the above. Even further, the cement waste form may include at least one suspension stability surfactant (e.g., sodium deoxycholate, anionic sodium dodecyl sulfate, polycarboxylate-based water reducing admixtures). Still further, the cement waste form may include at least one suspension stability enhanced nanostructure produced by chemical functionalization (e.g., oxidation to produce hydroxyl and/or carboxyl groups). Still further yet, the cement waste form may include at least one cementitious binder (e.g., ordinary Portland cement). Adding to this, the at least one cementitious binder may be selected from Portland cement, fly ash, and/or granulated blast furnace slag. Moreover, the waste source incorporated into the cement waste form may be incorporated as a liquid, slurry, or solid. Further again, the cementitious compo site may be modified at a nano, micro, and/or meso structure of the cementitious composite.

In a further embodiment, the current disclosure provides a method for making a cement waste form for radionuclide retention. The method may include oxidizing at least one carbon nanostructure via acid-etching to form anionic functional groups (e.g., hydroxyl, and/or carboxyl groups) on a surface of the at least one carbon nanostructure, forming a stable aqueous suspension containing the at least one carbon nanostructure dispersed therein, rendering the aqueous suspension alkaline to enhance stability of the at least one carbon nanostructure in the aqueous suspension, adding the aqueous suspension to at least one cementitious composite to form at least one nano-amended cementitious composite, incorporating at least one waste source into the nano-amended cementitious composite to form the cement waste form; and the at least one carbon nanostructure may be present from 0.001% to 0.005% by weight of at least one cementitious composite. Further, the at least one carbon nanostructure may be selected from at least one single-walled nanotube, at least one multiwalled nanotube, at least one partially-unzipped nanotube, at least one graphene nanoplatelet, at least one graphene nanoribbon, and/or combinations of the above. Again, the at least one cementitious composite may be selected from cementitious paste, cementitious mortar, cementitious grout and/or combinations of the above. Still yet, the method may include incorporating at least one suspension stability surfactant into the aqueous suspension. Moreover, the method may include incorporating at least one suspension-stabilizing functional group on the nanostructure to produce the aqueous suspension. Further yet, the method may include incorporating at least one cementitious binder into the aqueous suspension. Even further still, the at least one cementitious binder may be selected from Portland cement, fly ash, and/or granulated blast furnace slag. Further again, the method may include incorporating the waste source as a liquid, slurry, or solid. Still moreover, the method may include modifying the cementitious composite at a nano, micro, and/or meso structure of the cementitious composite.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a graphical summary of range of concentration of oxidized, surfactant-coated and unfunctionalized (ultrasonicated only) carbon nano-amendments in OPC paste (Iffat 2022) at: (a) MWCNT-amended OPC paste showing minimum concentrations of 0.02% and in excess of 1% in weight of OPC; and (b) graphene nanoplatelet-amended OPC paste showing minimum concentrations of 0.01% and in excess of 1% in weight of OPC.

FIG. 2 shows aqueous suspensions of different carbon nanostructures for manufacturing of in cementitious materials and waste forms at: (a) oxidized multiwalled carbon nanotubes (MWCNTs) in concentrations of 0.02, 0.1, 0.2 and 1 g/L from left to right (e.g., translating into MWCNT concentrations ranging from 0.001% to 0.05% in weight of OPC for OPC paste with water-to-cement mass ratio of 0.50); (b) oxidized partially-unzipped carbon nanotubes (PUCNTs) in concentrations of 0.02, 0.1, and 1 g/L from left to right (e.g., translating into PUCNT concentrations ranging from 0.001% to 0.05% in weight of OPC for OPC paste with water-to-cement mass ratio of 0.50); and (c) oxidized fully-unzipped carbon nanotubes, i.e., graphene nanoribbons (GNRs) in concentrations of 0.0125, 0.125, and 1.25 g/L from left to right (e.g., translating into GNR concentrations ranging from 0.000625% to 0.0625% in weight of OPC for OPC paste with water-to-cement mass ratio of 0.50).

FIG. 3 shows manufacturing of laboratory samples of OPC paste incorporating OPC, MWCNT aqueous suspension, and Tc spike, serving as proof-of-concept of concept of cementitious waste form material at: (a) mixing of dry and wet constituents; (b) casting in vials for curing prior to epoxy sealing; and (c) epoxy-sealed cylinder samples.

FIG. 4 shows manufacturing of laboratory samples of OPC paste incorporating OPC and MWCNT aqueous suspensions to investigate nano-, micro-, and meso-structural modifications resulting from carbon-nanostructure amendment at: (a) casting of prismatic specimens in acrylic molds; (b) wet-curing in saturated lime water; and (c) OPC samples after saw-cutting (for surface imaging) or crushing (for porosity testing and microscopic imaging).

FIG. 5 shows experimental results from proof-of-concept Tc leaching tests performed on Tc-spiked OPC paste specimens with MWCNT concentration of 0% (unamended), 0.001%, 0.005%, and 0.05% in mass of OPC. Data illustrate Tc leaching in percentage of total Tc mass in each OPC paste specimen as function of test time up to 63 days. Markers indicate mean values, error bars indicate standard deviation of results from four specimens.

FIG. 6 shows experimental results from mercury intrusion porosimetry (MIP) tests on OPC paste specimens with MWCNT concentration of 0% (unamended), 0.001%, 0.005%, and 0.05% in mass of OPC at: (a) total porosity as function of MWCNT concentration and wet-curing time where error bars indicate standard deviation of results from three specimens; and (b) representative pore size distribution curves for 14-day wet-cured OPC paste specimens where shaded range indicates more affected (i.e., refined) sub-micron pore sizes.

FIG. 7 shows scanning electron microscopy (SEM) micrographs illustrating nano- and micro-structure of unamended OPC paste and OPC paste amended with oxidized MWCNTs at: (a) unamended; (b) amended with MWCNTs in concentration of 0.001% in weight of OPC, illustrating pore-size refinement and defect bridging; and (c) amended with MWCNTs in concentration of 0.05% in weight of OPC. Arrows indicate debundled MWCNTs in areas of preferential formation of C—S—H. Dashed areas highlight presence of numerous bundled MWCNTs resulting from high concentration, and potentially acting as mechanical defect sites.

FIG. 8 shows SEM micrographs illustrating nano- and micro-structure of unamended OPC paste and OPC paste amended with oxidized PUCNTs at: (a) amended with PUCNTs in concentration of 0.001% in weight of OPC, showing debundled PUCNTs in areas of preferential formation of C—S—H; and (b) amended with PUCNTs in concentration of 0.05% in weight of OPC, showing numerous bundled PUCNTs resulting from high concentration, and potentially acting as mechanical defect sites.

FIG. 9 shows high-resolution micrographs of free surface (in direct contact with the curing water) of unamended and MWCNT-amended OPC paste showing the surface micro- and meso-structure after 14 days of wet-curing at: (a) unamended; and (b) amended with MWCNT concentration of 0.005% in weight of OPC.

FIG. 10 shows high-resolution micrographs of free surface (in direct contact with the curing water) of unamended and PUCNT-amended OPC paste showing surface micro- and meso-structure after 28 days of wet-curing at: (a) unamended; and (b) amended with PUCNTs concentration of 0.005% in weight of OPC.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance, or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

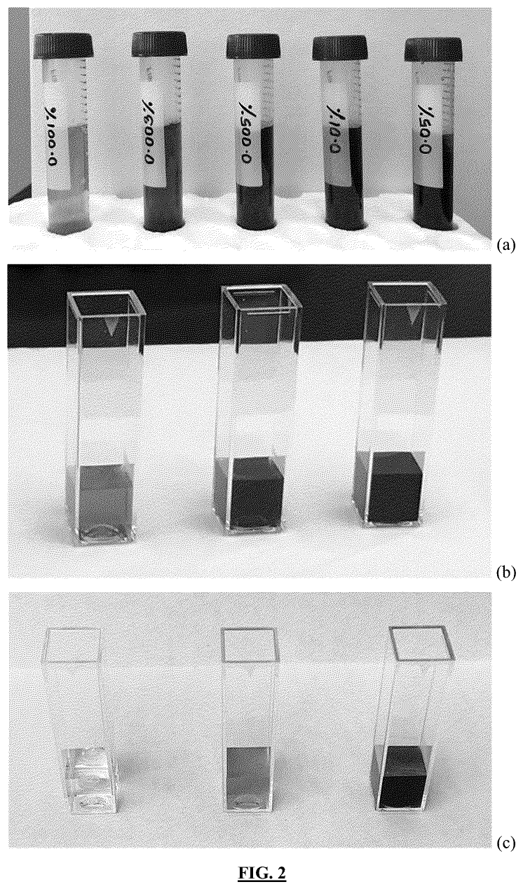

As used herein (e.g., FIG. 2), the term “wt %” indicates the concentration of a given carbon nanostructure by total weight of cementitious binders (e.g., OPC), unless otherwise specified. That is, unless otherwise specified, all wt % values are based on the total weight of the cementitious binders included in a disclosed composition or formulation.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure, or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites, and other published materials cited herein are hereby incorporated by reference to the same extent as though each individual publication, published patent document, or patent application was specifically and individually indicated as being incorporated by reference. To wit, this disclosure herein incorporates by reference Oxidized Graphitic Nano-Amendment of Cement Composites: Exploring Truly Low Concentrations and Novel Particle Morphologies, Shohana Iffat, 2022.

The present disclosure provides methods for making cement waste forms comprising carbon nanostructures as amendments to cement paste to enhance radionuclide and hazardous waste retention. The intended nano-amendments comprise any form of carbon nanostructures such as single- and multiwalled nanotubes, partially-unzipped nanotubes, graphene nanoplatelets, and graphene nanoribbons. Further, the intended cementitious composites comprise any form of paste, mortar, and grout, incorporating a cementitious binder (e.g., ordinary Portland cement, fly ash, granulated blast furnace slag, etc.).

This disclosure also provides incorporation of carbon nanostructures (i.e., multiwalled nanotubes, partially-unzipped nanotubes, graphene nanoribbons) in cementitious waste forms to enhance retention of low-level radionuclide waste and hazardous constituent waste in liquid, slurry, or solid forms.

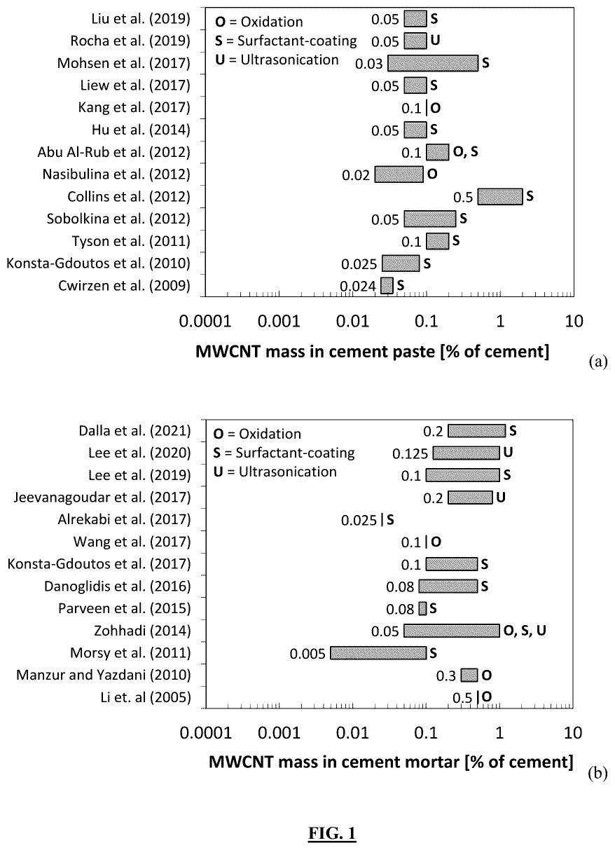

The concentration of carbon nanostructures is as high as 0.05% in weight of OPC. Such concentration is considered a lower bound to efficiently take advantage of the relatively high specific surface area of chemically affine carbon nanostructures. This is reflected in the most recent archival literature, as summarized in FIG. 1 at (a) for MWCNT-amended OPC paste, and in FIG. 1 at (b) for graphene nanoplatelet-amended OPC paste. Yet, there is arguably no evidence that meaningful enhancements cannot be attained by further reducing the nano-amendment concentration. To test this hypothesis, empirical evidence from cementitious composites with carbon nano-amendment concentrations as low as 0.001% in weight of OPC (see, Iffat 2022) is provided herein.

The objective is to understand whether the resulting physical changes in the cementitious composite contribute to offsetting the leaching of low-level nuclear waste, with an emphasis on technetium (Tc) in its mobile form as a most representative example. Over the last two decades, it has been demonstrated that the incorporation of MWCNTs in OPC paste and mortar results in enhanced strength and stiffness properties and refined porosity. These ameliorations can curtail Tc re-oxidation and leaching by hindering oxygen diffusion, which may be facilitated in the presence of open pores and cracks (e.g., due to shrinkage).

In fact, through experimental research reported in archival publications, it has been shown that the incorporation of carbon nanostructures (typically MWCNTs) in concentrations as low as 0.05% in weight of OPC can significantly alter different physico-mechanical properties of OPC paste and mortar. Notable examples include increases in tensile strength and elastic stiffness (Konsta-Gdoutos et al. 2010, Gdoutos et al. 2016), decrease in cumulative porosity (Li et al. 2005), and pore size refinement (Nochaiya and Chaipanich 2005). Contributing factors may include the intrusion of MWCNTs in voids (Iffat 2022), and the accelerated and more effective hydration due to the carbon nanostructures acting as preferential precipitation sites (Makar and Chan 2009, Iffat 2022), which may also facilitate the formation of high-stiffness C—S—H (Konsta-Gdoutos et al. 2010). These ameliorations are of interest since reduced and refined porosity paired with better resistance to crack formation are ideal attributes for cement composites serving as low-level nuclear waste forms.

Leaching tests following the EPA 1315 procedure were performed on nine-day moist-cured OPC paste specimens. The samples were prepared using oxidized MWCNTs and 0.327 mg Tc/kg of cement. Four specimens were tested for each MWCNT concentration ranging from 0% (plain control specimens) to 0.05%. Empirical results after 63 days of testing show a decrease in the average Tc leachate mass ranging from 30% to 47% for 0.005% and 0.05% MWCNT concentrations in weight of OPC, respectively. Additional experimental evidence was obtained through porosity measurements and scanning electron microscopy imaging. This evidence supports the hypothesis that accelerated hydration and porosity reduction in carbon nanostructure-amended specimens are key contributors to reducing leaching of Tc.

All experiments were conducted on cement paste consisting of Type I OPC and deionized (DI) water, with a water-to-cement weight ratio of 0.50. The OPC paste material was manufactured in accordance with the procedure specified in ASTM C305 (2020).

MWCNTs with a nominal maximum diameter of 8 nm (Cheap Tubes Inc., Cambridgeport, VT) were used as nano-amendments. These MWCNTs were oxidized following the acid-etching approach as described by Langley and Fairbrother (2007) for the functionalization of carbon char, and demonstrated by Aich et al. (2012), Zohhadi (2014), and Iffat (2022). The objective was to form functional OH and COOH groups on the surface of the MWCNTs, thereby minimizing reagglomeration and rendering the nano-amendments chemically affine with the surrounding cement matrix (Li et al. 2005). To this end, individual batches of 0.5 g of MWCNTs were added to 0.2 L of 1M of sulfuric acid solution containing 750 g/L of ammonium persulfate. The suspension was sonicated for 10 minutes, and then stirred at 1200 rpm for 24 hours under ambient temperature. Then, the acid-treated MWCNTs were filtered, washed with DI water until the filtrate attained a pH of 7.0, and dried at ambient temperature for three days over a CaCl₂) desiccant.

DI water was used to make aqueous suspensions with well-dispersed oxidized MWCNTs, as shown in FIG. 2 at (a) as well as for other carbon nanostructures in FIG. 2 at (b) and (c). The MWCNT aqueous suspensions were used to manufacture nano-amended OPC specimens used for Tc leaching tests, porosity tests, and scanning electron microscopy (SEM) imaging. A small amount of NaOH (˜5 mol/L) was used to raise the pH to 12 to deprotonate the functional group and enhance the stability of the MWCNTs in water. The stability of the resulting suspensions was verified using dynamic light scattering hydrodynamic size and zeta potential measurements; in fact, the zeta potential values were consistently between −50 and −60 mV.

Suspension stability, and the quantitative characterization thereof, rather than based on mere visual inspection, is important to minimize the agglomeration of nanostructures in the aqueous solutions that are added to the dry constituents (e.g., OPC) to manufacture cement waste forms; in fact, the presence of agglomerated nanostructures in cementitious composites produce physical discontinuities, and thus inhomogeneities, which are likely to act as defects (Iffat 2022). These defects may negatively affect mechanical properties related to durability, which are also relevant for waste retention (e.g., compressive and tensile strength, elastic modulus, resistance to shrinkage-related deformations). Further, the disclosure also provides for suspension stability provided through chemically functionalizing, through oxidation to produce hydroxyl and/or carboxyl groups. Acid-etching may also be used to accomplish. Other suspension stability surfactants, such as sodium deoxycholate, anionic sodium dodecyl sulfate, polycarboxylate-based water reducing admixtures, etc., may be employed as well.

Leaching Test Specimens, Setup, and Procedure

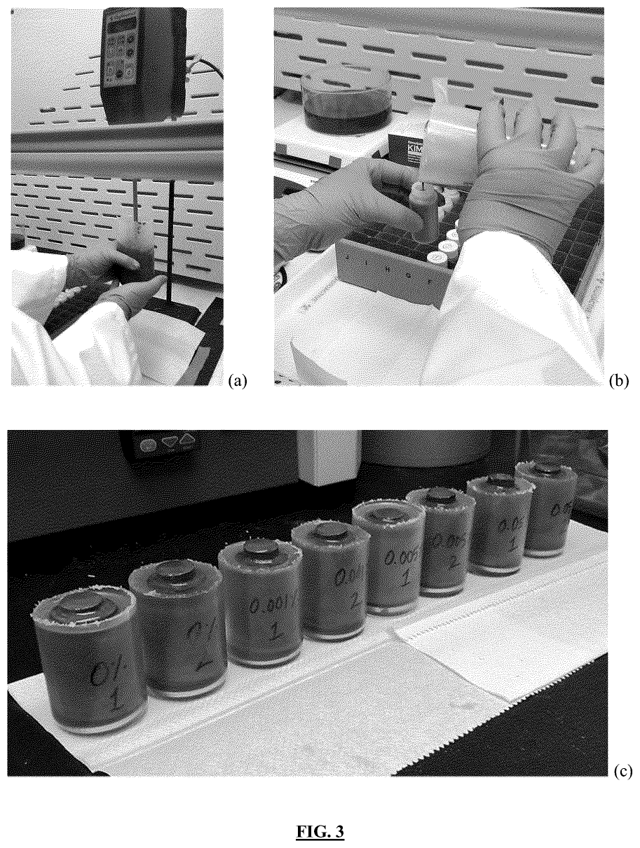

Technetium leaching tests were performed on unamended and MWCNT-amended OPC paste specimens in general conformance with the EPA 1315 procedure (EPA 2017). All specimens were prepared by mixing water or MWCNT-aqueous suspension for unamended and MWCNT-amended specimens, respectively, with OPC and Tc spike, resulting in a Tc concentration of 0.327 mg Tc/kg of OPC. Then, the mixtures were cast on 20 mL scintillation vials, and left to moist-cure for nine days. The preparation of the specimens is shown in FIG. 3 (a) and (b).

Following the curing time, each monolith was removed from the scintillation vials, placed in the center of a 60 mL polypropylene bottle that was subsequently filled with epoxy resin, and left to harden for five days, see FIG. 3 at (c). Finally, each sealed monolith was saw-cut to obtain two specimens, each with two fresh 25-mm diameter OPC paste faces.

Four specimens were tested for each of four MWCNT concentrations (0%, 0.001%, 0.005%, and 0.05% in weight of OPC). Each specimen was placed into a 500 mL polypropylene bottle and covered with about 90 mL of DI water, as determined from the liquid to surface area ratio of 9+/−1 mL/cm 2 specified by EPA (2017). From the time each specimen was placed into the bottle and submerged, the EPA 1315 procedure (EPA 2017) was implemented to determine the interval times for the removal and characterization of each leachate (nine interval times between 0 and 63 days). At each interval, the leachate was removed and characterized for total mass. Technetium concentrations were measured using external calibration on an inductively coupled plasma mass spectrometer (Thermo Scientific XSeries 2 ICP-MS, Thermo Fisher Scientific Inc., Waltham, MA) in a 2% nitric acid matrix.

Porosity Test Specimens, Setup, and Procedure

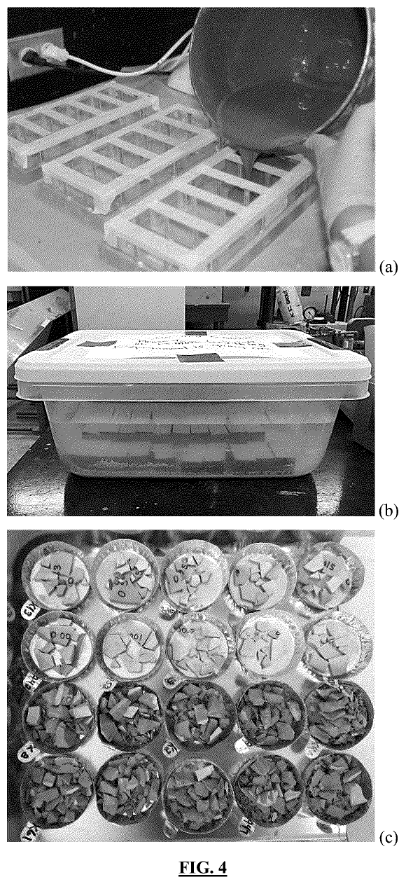

Unamended and MWCNT-amended OPC paste prisms with dimensions 25 mm×25 mm×76 mm were cast, moist-cured for 24 hours in sealed acrylic molds, and then cured in saturated lime water for additional 6, 13 and 27 days to produce specimens with curing age of 7, 14 and 28 days, respectively. The prisms were then saw-cut or crushed to extract small samples for SEM imaging and porosity testing. The preparation of these specimens is documented in FIG. 4 at (a-c).

For each MWCNT concentration, three to five samples with maximum size between 7 and 15 mm were dried for 24 hours under room temperature. Each sample was tested using a mercury intrusion porosimeter with a suggested pore diameter range of 0.006 to 1000 μm (PoreMaster 33, Quantachrome Instruments, Boynton Beach, FL). For each sample, low-pressure (1.38-345 kPa) and high-pressure (345 kPa-228 MPa) testing was completed in approximately two hours.

Scanning Electron Microscopy Imaging Specimens and Procedure

A portion of the crushed OPC paste specimens extracted from the 25 mm×25 mm×76 mm OPC paste prisms was used for SEM imaging, with the objective of visually characterizing the internal structure of unamended vis-à-vis MWCNT-amended specimens. These fragment samples had a maximum size of 5 mm.

Instead, saw-cut OPC paste specimens were used for the SEM imaging of the physical structure of free surfaces, that is, surfaces that had been in direct contact with the curing lime-saturated water solution. These surfaces became of interest after observing that MWCNT-amended specimens were visibly smoother to the touch whereas the unamended counterparts had the rough surface characteristic of OPC paste (as well as mortar and grout). This observation suggested that significant modifications were introduced by incorporating well-dispersed MWCNTs.

A field-emission scanning electron microscope (Ultraplus Thermal Field Emission Scanning Electron Microscope, Zeiss) was enlisted to observe the structure of the composite matrix as well as the distribution of MWCNTs in the crushed OPC paste specimens, thus making it possible to obtain high-magnification SEM micrographs while minimizing electrostatic distortions.

A different microscope (SEM Vega3, TESCAN) was utilized to obtain lower-magnification and detailed images of the free surfaces of the unamended and MWCNT-amended OPC paste specimens.

Leaching Test Results

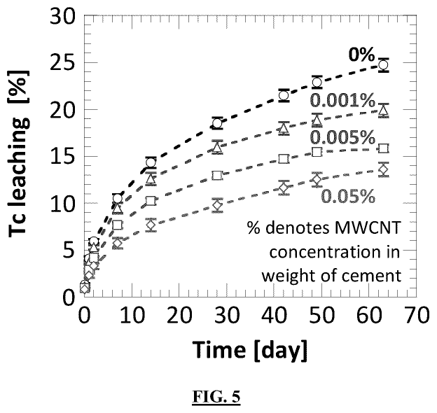

The quantitative results of the 63-day Tc leaching tests are summarized in the plot in FIG. 5 where the data illustrate Tc leaching in percentage of total Tc mass as a function of MWCNT concentration (between 0% and 0.05% in weight of OPC) and test time up to 63 days. For each data point, the marker and associated error bars indicate the average and the standard deviation of the results from four specimens.

Compared to the unamended OPC specimens, these results show an average decrease in Tc leachate of 30% and 47% in weight for the nano-amended specimens with 0.005% and 0.05% MWCNT concentration, respectively. As indicated by the error (standard deviation) bars for sets of four specimens, such decrease is consistent. This evidence appears promising for researchers who are interested in investigating the incorporation of MWCNT-amendments in cementitious reducing waste forms such as saltstone.

It is noted that a significant leaching reduction is attained when using an extremely small amount of MWCNTs, 0.005% in weight of OPC. In fact, this concentration is 10 times smaller than the 0.05% concentration, which is regarded in the literature as a lower bound to yield meaningful enhancements to cement composites (e.g., Konsta-Gdoutos et al. 2010, Zohhadi 2014, Gdoutos et al. 2016). This evidence shows promising potential to obtain significant results with smaller MWCNT concentrations, with the goal of reducing costs and taking better advantage of the relatively large surface area-to-weight ratio of MWCNTs.

The trend lines of the data presented in FIG. 5 seem to become nearly asymptotic at increasing testing times. This trend suggests that the rate of the leaching reduction may stabilize over time as curing proceeds, without further marked increases in the gap between plain and MWCNT-amended OPC paste.

Porosity Test Results

The mercury intrusion porosimetry data were processed using the generalized form of Washburn equation, upon applying the following four correction factors discussed by Cook and Hover (1993): blank run, differential mercury compression, hydrostatic head of mercury, and change in surface tension with pore size.

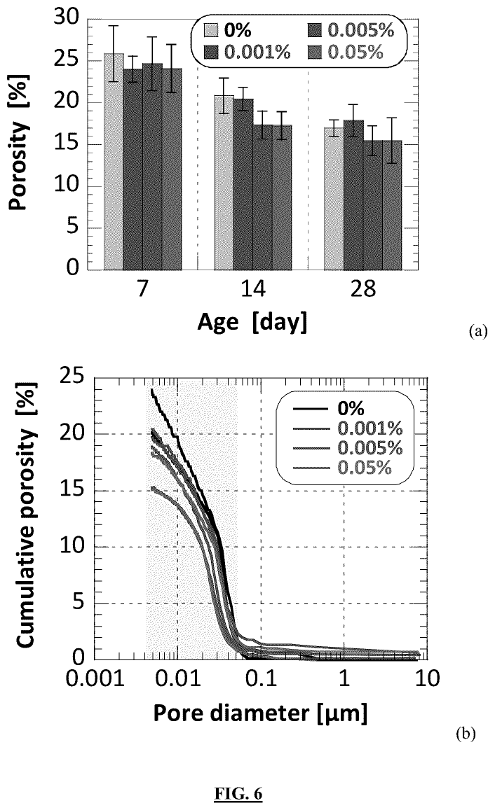

FIG. 6 at (a) presents a histogram showing the total porosity as a function of MWCNT concentration (between 0% and 0.05% in weight of OPC) and wet-curing time where error bars indicate standard deviation of results from three specimens. FIG. 6 at (b) presents representative pore size distribution curves for 14-day wet-cured OPC paste specimens where the shaded range indicates more affected (i.e., refined) sub-micron pore sizes.

This empirical evidence indicates that: (i) the total porosity tends to decrease at increasing MWCNT concentrations; and (ii) this decrease is due primarily to a reduction of the volume of sub-micron pores. Such effect has been reported in the literature for much larger MWCNT concentrations in the range 0.5%-1.0% in weight of OPC (Li et al. 2005, Nochaiya and Chaipanich 2005), and may be attributed to the intrusion of MWCNTs in voids (Iffat 2022), and the more effective formation of cement hydrates around dispersed MWCNTs (Iffat 2022). To this end, supporting visual evidence was sought through SEM imaging.

High-Resolution Imaging of Physical Structure

Microscopic imaging was enlisted to gain visual evidence on the nano-, micro- and meso-structure of the unamended and MWCNT-amended OPC paste in this embodiment. Specifically, SEM micrographs of the physical structure of the OPC paste were obtained from crushed specimens whereas SEM micrographs of the free surface were obtained from saw-cut specimens.

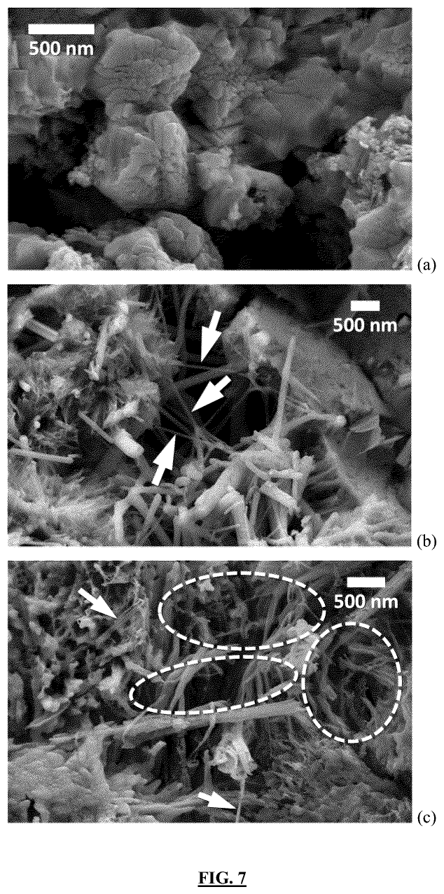

Representative SEM micrographs illustrating the physical structure of 7-day wet-cured OPC paste, unamended as well as amended with oxidized MWCNTs, are shown in FIG. 7.

Compared to unamended OPC paste in FIG. 7 at (a), amended OPC paste with a MWCNT concentration of only 0.001 wt % in FIG. 7 at (b) exhibits a fundamentally different structure that is characterized by: (i) accelerated and preferential formation of calcium silicates hydrates (C—S—H) in the vicinity of the carbon nano-amendments, which is notable since C—S—H is a major contributor to mechanical strength and stiffness for a cementitious composite; (ii) presence of well-distributed and debundled MWCNTs that provide pore-size refinement, thus consistent with the findings from leaching tests (FIG. 5) and porosity tests (FIG. 6); (iii) MWCNTs acting as defect bridging nanostructures by partially filling voids; and (iv) MWCNTs potentially acting as physical barriers that are well-distributed throughout the cementitious composite, and may facilitate the waste retention highlighted by the empirical evidence in FIG. 5.

A similar physical structure is observed in FIG. 7 at (c) for OPC paste amended with MWCNTs in concentration of 0.05 wt %; however, this evidence also shows the frequent agglomeration of MWCNTs that potentially act as mechanical defect sites, suggesting that smaller MWCNT concentrations should be considered.

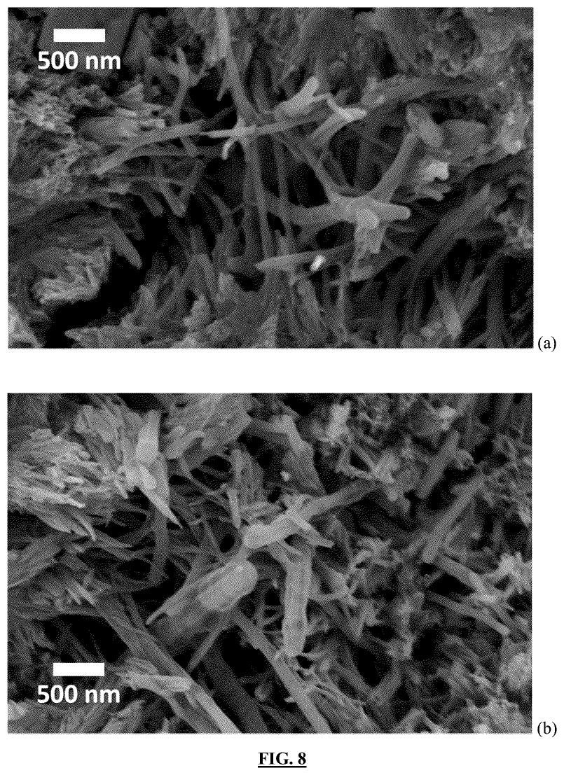

Similar considerations apply for other carbon nano-amendments as supported by the evidence in FIG. 8, which shows SEM micrographs illustrating the physical structure of 28-day wet-cured OPC paste amended with oxidized PUCNTs in concentration of 0.001 wt % in FIGS. 8 at (a), and 0.05 wt % in FIG. 8 at (b). While both PUCNT concentrations appear to facilitate the preferential formation of C—S—H, it is evident that the higher concentration results in the formation of numerous bundles of PUCNTs, which produce inhomogeneities and, thus, potential defect sites.

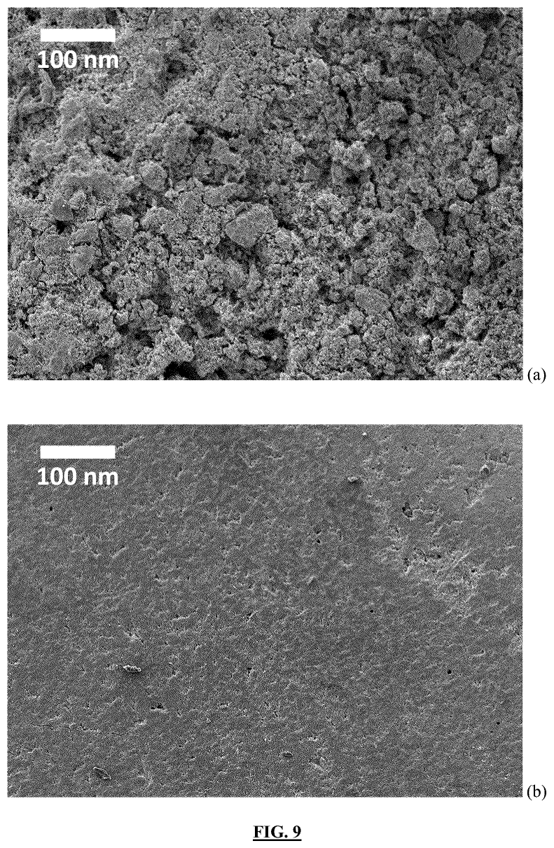

FIG. 9 shows representative SEM micrographs of the free surface of 14-day cured OPC paste: unamended in FIG. 9 at (a); and amended with a MWCNT concentration of 0.005% in weight of OPC in FIG. 9 at (b).

The difference is remarkable even when considering the curing surface of OPC paste with a MWCNT concentration of only 0.005 wt %. In fact, the MWCNT-amended OPC paste exhibits a notably less porous surface structure with a better-distributed formation of hydrates compared to the unamended counterpart. This visual evidence, together with the Tc leaching test results, supports the hypothesis that surface structure modification resulting from the incorporation of well-dispersed MWCNTs is an important factor to curtailing oxygen ingress, and thus Tc re-oxidation and leaching.

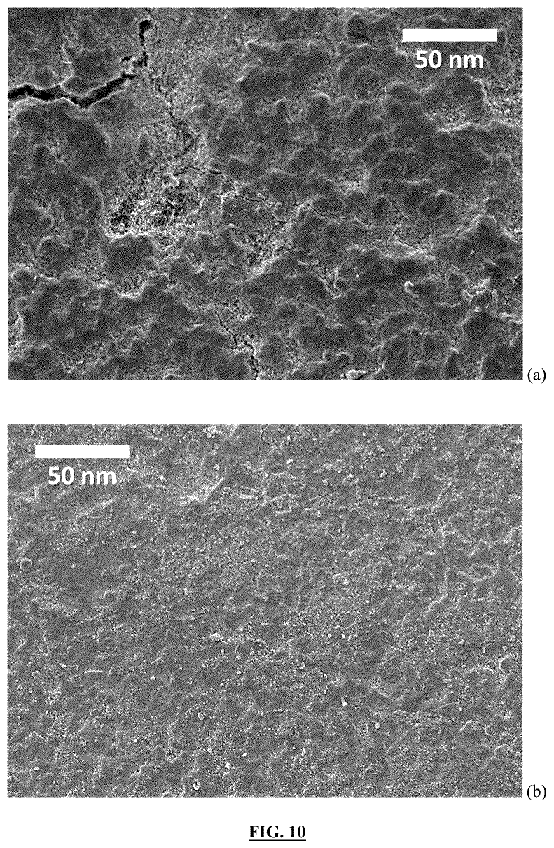

Similar considerations apply for other carbon nano-amendments as supported by the evidence in FIG. 10, which shows high-resolution micrographs of the free surface of 28-day wet-cured OPC paste: unamended in FIG. 10 at (a); and amended with a PUCNT concentration of 0.005 wt % in FIG. 10 at (b). These specimens were manufactured following the same procedure of the MWCNT-amended OPC paste specimens, and show similar results for the surface structure.

Based on the empirical evidence presented herein, the following conclusions are drawn. The incorporation of well-dispersed MWCNTs in cement waste forms has the potential to reduce the leaching of Tc in its mobile form.

Leaching significantly decreased also when using MWCNT concentration of 0.001% and 0.005% in weight of OPC, thus up to 50 times less what is considered a lower bound for high performance in the archival literature (Iffat 2022). The evidence presented herein highlights the potential to obtain significant results when reducing such concentrations further, thereby taking better advantage of the large surface area-to-weight ratio of MWCNTs.

The evidence from porosity measurements and SEM imaging presented herein support the hypothesis that the incorporation of well-dispersed MWCNTs (as well as other carbon nanostructures) leads to a decrease in Tc leaching because it facilitates the accelerated and more extensive formation of cement hydrates, thereby: (i) reducing the total porosity; (ii) refining the nano-scale porosity; and (iii) leading to the formation of a less pervious material that rapidly acts as a shield for oxygen intrusion as well as Tc leaching.

Similar conclusions apply to other carbon nanostructures such as PUCNTs, graphene nanoplatelets, and GNRs.

Per this disclosure, ranges of the at least one carbon nanostructure may be present from 0.0005% to 0.05% by weight of binder and/or cementitious composite, such as from 0.001% to 0.05% weight per binder and/or cementitious composite, etc.

### Acknowledgements

Dr. Mabel Cuéllar-Azcárate for assistance with preparing Tc-spiked cement paste samples and performing Tc leaching tests.

Dr. Ernest M. Wylie for assistance with preparing Tc-spiked cement paste samples, and selecting the protocol for and performing Tc leaching tests.

Dr. Leydy Mejia Cruz for assistance with performing porosity tests.

Dr. Mithun Sikder for assistance with performing dynamic light scattering tests.

Dr. Yuyu Xie for assistance with performing Tc leaching tests.

Dr. Brian A. Powell for providing access to laboratory facilities to prepare Tc-spiked cement paste samples, and selecting the protocol for and performing Tc leaching tests.

### REFERENCES

All of these references below are hereby incorporated by reference:
Abu Al-Rub R K, Ashour A I, Tyson B M. On the Aspect Ratio Effect of Multi-Walled Carbon Nanotube Reinforcements on the Mechanical Properties of Cementitious Nanocomposites. Construction and Building Materials 2012; 35, 647-655. doi.org/10.1016/j.conbuildmat.2012.04.086
Aich N, Zohhadi N, Khan I A, Matta F, Ziehl P, and Saleh N B. Applied TEM Approach for Micro/Nanostructural Characterization of Carbon Nanotube Reinforced Cementitious Composites. Journal of Research Updates in Polymer Science 2012; 1, 14-23. dx. doi.org/10.6000/1929-5995.2012.01.01.3
Alrekabi S, Cundy A B, Lampropoulos A, Whitby R L D, Savina I. Effect of High-Intensity Sonication on the Dispersion of Carbon-Based Nanofilaments in Cementitious Composites, and Its Impact on Mechanical Performance. Materials and Design 2017; 136, 223-237. doi.org/10.1016/j.matdes.2017.09.061
Collins F, Lambert J, Duan W H. The Influences of Admixtures on the Dispersion, Workability, and Strength of Carbon Nanotube—OPC Paste Mixtures. Cement and Concrete Composites 2012; 34, 201-207. //doi.org/10.1016/j.cemconcomp.2011.09.013
Danoglidis P A, Konsta-Gdoutos M S, Gdoutos E E, Shah S P. Strength, Energy Absorption Capability and Self-Sensing Properties of Multifunctional Carbon Nanotube Amended Mortars. Construction and Building Materials 2016; 120, 265-274. //doi.org/10.1016/j.conbuildmat.2016.05.049
Gdoutos E E, Konsta-Gdoutos M S, Danoglidis P A, Shah S P. Advanced Cement Based Nanocomposites Reinforced with MWCNTs and CNFs. Frontiers of Structural and Civil Engineering 2016; 10, 142-149. doi.org/10.1007/s11709-016-0342-1
Hu Y, Luo D, Li P, Li Q, Sun G, Key S. Fracture Toughness Enhancement of Cement Paste with Multi-Walled Carbon Nanotubes. Construction and Building Materials 2014; 70, 0332-338. doi.org/10.1016/j.conbuildmat.2014.07.077
Iffat S. Oxidized Graphitic Nano-Amendment of Cement Composites: Exploring Truly Low Concentrations and Novel Particle Morphologies. PhD Dissertation 2022; University of South Carolina, Columbia, SC, USA. scholarcommons.sc.edu/etd/6991
Jeevanagoudar Y V, Krishna R H, Gowda R, Preetham R, Prabhakara R. Improved Mechanical Properties and Piezoresistive Sensitivity Evaluation of MWCNTs Amended Cement Mortars. Construction and Building Materials 2017; 144, 188-194. doi.org/10.1016/j.conbuildmat.2017.03.139
Kang S T, Seo J Y, Park S H. The Characteristics of CNT/Cement Composites with Acid-Treated MWCNTs. Advances in Materials Science and Engineering 2015; Article ID 308725. doi.org/10.1155/2015/308725
Konsta-Gdoutos M S, Batis G, Danoglidis P A, Zacharopoulou A K, Zacharopoulou E K, Falara M G, Shah S P. Effect of CNT And CNF Loading and Count on the Corrosion Resistance, Conductivity and Mechanical Properties of Nanomodified OPC Mortars. Construction and Building Materials 2017; 147, 48-57. doi.org/10.1016/j.conbuildmat.2017.04.112
Konsta-Gdoutos M S, Metaxa Z S, Shah S P. Multi-Scale Mechanical and Fracture Characteristics and Early-Age Strain Capacity of High Performance Carbon Nanotubes/Cement Nanocomposites. Cement and Concrete Composites 2010; 32 (2), 110-115. doi.org/10.1016/j.cemconcomp 0.2009.10.007
Lee H, Jeong S, Cho S, Chung W. Enhanced Bonding Behavior of Multi-Walled Carbon Nanotube Cement Composites and Reinforcing Bars. Composite Structures 2020; 243, 112201. doi.org/10.1016/j.compstruct.2020.112201
Lee H, Jeong S, Park S, Chung W. Enhanced Mechanical and Heating Performance of Multi-Walled Carbon Nanotube-Cement Composites Fabricated Using Different Mixing Methods. Composite Structures 2019; 225, 111072. doi.org/10.1016/j.compstruct.2019.111072
Li G Y, Wang P M, Zhao X. Mechanical Behavior and Microstructure of Cement Composites Incorporating Surface-Treated Multi-Walled Carbon Nanotubes, Carbon 2005; 43, 1239-1245. doi.org/10.1016/j.carbon.2004.12.017
Liew K M, Kai M F, Zhang L W. Mechanical and Damping Properties of CNT-Amended Cementitious Composites. Composite Structures 2017; 160, 81-88. doi.org/10.1016/j.compstruct.2016.10.043
Liu J, Fu J, Ni T, Yang Y. Fracture Toughness Improvement of Multi-Wall Carbon Nanotubes/Graphene Sheets Reinforced Cement Paste. Construction and Building Materials 2019; 200, 530-538. doi.org/10.1016/j.conbuildmat.2018.12.141
Makar J M, Chan G W. Growth of Cement Hydration Products on Single-Walled Carbon Nanotubes. Journal of the American Ceramic Society 2009; 92 (6), 1303-1310. doi.org/10.1111/j.1551-2916.2009.03055.x
Manzur T, Yazdani N. Strength Enhancement of Cement Mortar with Carbon Nanotubes: Early Results and Potential. Transportation Research Record: Journal of the Transportation Research Board 2010; 2142, 102-108. doi.org/10.3141/2142-15
Mohsen M O, Taha R, Taqa A A, Shaat A. Optimum Carbon Nanotubes' Content for Improving Flexural and Compressive Strength of Cement Paste. Construction and Building Materials 2017; 150, 395-403. doi.org/10.1016/j.conbuildmat.2017.06.020
Morsy M S, Alsayed S H, Aqel M. Hybrid Effect of Carbon Nanotube and Nano-Clay on Physico-Mechanical Properties of Cement Mortar. Construction and Building Materials 2011; 25, 145-149. doi.org/10.1016/j.conbuildmat.2010.06.046
Nasibulina L I, Anoshkin I V, Nasibulin A G, Cwirzen A, Penttala V, Kauppinen E I. Effect of Carbon Nanotube Aqueous Dispersion Quality on Mechanical Properties of Cement Composite. Journal of Nanomaterials 2012; Article ID 169262. doi.org/10.1155/2012/169262
Nochaiya T and Chaipanich A. Behavior of Multi-Walled Carbon Nanotubes on the Porosity and Microstructure of Cement-Based Materials. Applied Surface Science 2011; 257, 1941-1945. doi.org/10.1016/j.apsusc.2010.09.030
Parveen S, Rana S, Fangueiro R, Paiva M C. Microstructure and Mechanical Properties of Carbon Nanotube Amended Cementitious Composites Developed Using A Novel Dispersion Technique. Cement and Concrete Research 2015; 73, 215-227. doi.org/10.1016/j.cemconres.2015.03.006
Rocha V V, Ludvig P, Trindade A C C, Silva F A. The Influence of Carbon Nanotubes on the Fracture Energy, Flexural and Tensile Behavior of Cement Based Composites. Construction and Building Materials 2019; 209, 1-8. doi.org/10.1016/j.conbuildmat.2019.03.003
Sobolkina A, Mechtcherine V, Khavrus V, Maier D, Mende M, Ritschel M, Leonhardt A. Dispersion of Carbon Nanotubes and Its Influence on the Mechanical Properties of the Cement Matrix. Cement and Concrete Composites 2012; 34 (2012), 1104-1113. doi.org/10.1016/j.cemconcomp.2012.07.008
Tyson B M, Abu Al-Rub R K, Yazdanbakhsh A, Grasley Z. Carbon Nanotubes and Carbon Nanofibers for Enhancing the Mechanical Properties of Nanocomposite Cementitious Materials. Journal of Materials in Civil Engineering 2011; 23(7), 1028-1035. doi.org/10.1061/(ASCE)MT.1943-5533.0000266
Wang Y, Hu H, Rong C. The Effect of the Diameter of Carbon Nanotube on the Mechanical and Electrical Properties of Cement Mortar. Key Engineering Materials 2017; 730, 479-485. doi.org/10.4028/www.scientific.net/KEM.730.479
Zohhadi N. Functionalized Graphitic Nanoreinforcement for Cement Composites. PhD Dissertation 2014; University of South Carolina, Columbia, SC, USA. scholarcommons.sc.edu/etd/2939

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A cement waste form for radionuclide or hazardous constituent (e.g., heavy metals) retention comprising:
at least one carbon nanostructure added to at least one cementitious composite to modify a structure of the cementitious composite to form at least one nano-amended cementitious composite;
at least one waste source incorporated into the nano-amended cementitious composite to form the cement waste form;
the at least one carbon nanostructure is present from 0.001% to 0.05% by weight of the at least one cementitious composite; and
the cement waste form is configured to enhance radionuclide retention by limiting oxygen and water ingress into the cement waste form.

2. The cement waste form for radionuclide or hazardous constituent retention of claim 1, wherein the at least one carbon nanostructure is selected from at least one single-walled nanotube, at least one multiwalled nanotube, at least one partially-unzipped nanotube, at least one graphene nanoplatelet, at least one graphene nanoribbon, and/or combinations of the above.

3. The cement waste form for radionuclide or hazardous constituent retention of claim 1, wherein the at least one cementitious composite is selected from cementitious paste, cementitious mortar, cementitious grout and/or combinations of the above.

4. The cement waste form for radionuclide or hazardous constituent retention of claim 1, further comprising at least one suspension stability surfactant.

5. The cement waste form for radionuclide or hazardous constituent retention of claim 1, further comprising at least one suspension stability functional group.

6. The cement waste form for radionuclide or hazardous constituent retention of claim 1, further comprising at least one cementitious binder.

7. The cement waste form for radionuclide or hazardous constituent retention of claim 6, further comprising wherein the at least one cementitious binder is selected from Portland cement, fly ash, and/or granulated blast furnace slag.

8. The cement waste form for radionuclide or hazardous constituent retention of claim 1, further comprising wherein the waste source incorporated into the cement waste form is incorporated as at least one liquid, at least one slurry, and/or at least one solid.

9. The cement waste form for radionuclide or hazardous constituent retention of claim 1, further comprising wherein the cementitious composite is modified at a nano, micro, and/or meso structure of the cementitious composite.

10. A method for making a cement waste form for radionuclide or hazardous constituent retention comprising:
oxidizing at least one carbon nanostructure via acid-etching to form anionic functional hydroxyl and/or carboxyl groups on a surface of the at least one carbon nanostructure;
forming an aqueous suspension containing the at least one carbon nanostructure dispersed therein;
rendering the aqueous suspension alkaline to enhance stability of the at least one carbon nanostructure in the aqueous suspension;
adding the aqueous suspension to at least one cementitious composite to form at least one nano-amended cementitious composite;
incorporating at least one waste source into the nano-amended cementitious composite to form the cement waste form; and
the at least one carbon nanostructure is present from 0.001% to 0.005% by weight of at least one cementitious composite.

11. The method for making a cement waste form for radionuclide or hazardous constituent retention of claim 10, wherein the at least one carbon nanostructure is selected from at least one single-walled nanotube, at least one multiwalled nanotube, at least one partially-unzipped nanotube, at least one graphene nanoplatelet, at least one graphene nanoribbon, and/or combinations of the above.

12. The method for making a cement waste form for radionuclide or hazardous constituent retention of claim 10, wherein the at least one cementitious composite is selected from cementitious paste, cementitious mortar, cementitious grout and/or combinations of the above.

13. The cement waste form for radionuclide or hazardous constituent retention of claim 10, further comprising incorporating at least one suspension stability surfactant into the aqueous suspension.

14. The cement waste form for radionuclide or hazardous constituent retention of claim 10, further comprising incorporating at least one suspension stability functional group into the aqueous suspension.

15. The method for making a cement waste form for radionuclide or hazardous constituent retention of claim 10, further comprising incorporating at least one cementitious binder into the aqueous suspension.

16. The method for making a cement waste form for radionuclide or hazardous constituent retention of claim 15, further comprising wherein the at least one cementitious binder is selected from Portland cement, fly ash, and/or granulated blast furnace slag.

17. The method for making a cement waste form for radionuclide or hazardous constituent retention of claim 10, further comprising incorporating the waste source in a form of at least one liquid, at least one slurry, and/or at least one solid.

18. The method for making a cement waste form for radionuclide or hazardous constituent retention of claim 10, further comprising modifying the cementitious composite at a nano, micro, and/or meso structure of the cementitious composite.
